(19) United States
(12) Patent Application Publication
(10) Pub. No.: US 2013/0286544 A1
(43) Pub. Date: Oct. 31, 2013

(54) ASSEMBLY INTENDED FOR STORING ELECTRICAL ENERGY AND HAVING A STACKED ELEMENT

(71) Applicant: Philippe Azais, Quimper (FR)

(72) Inventor: Philippe Azais, Quimper (FR)

(21) Appl. No.: 13/979,369

(22) PCT Filed: Jan. 13, 2012
(86) PCT No.: PCT/EP12/50480

§ 371 Date: Jul. 11, 2013

(30) Foreign Application Priority Data
Jan. 13, 2011 (FR) 1150269

(51) Int. Cl. H01G 11/04

(52) U.S. Cl. CPC H01G 11/04
USPC 361/502

(57) ABSTRACT

The invention relates to an assembly for storing electrical energy, including: at least four stacked complexes (1, 1′;2, 2′), each including at least one electrode; at least one separator (3), the separator(s) being arranged such that a separator is arranged between each pair of adjacent complexes; two connecting terminals for electrically connecting the assembly to a voltage generator, a first sample of complexes (1′) being electrically connected to or constituting the first of the two terminals, and a second sample of complexes (2′) being electrically connected to or constituting the other of the two terminals, the two samples being selected such that the number of complexes belonging to the combination of the two samples is less than the total number of complexes, and that the intersection of the two samples is an empty set.

The present invention concerns the general technical field of electrical energy storage assemblies.

In the present invention by “electrical energy storage assembly” is meant a supercapacitor (i.e. a system comprising at least two electrodes whose material is of same type—for example activated carbon—an electrolyte and at least one separator) or a battery (i.e. a system comprising at least two electrodes made in different materials, an electrolyte and at least one separator) or an electrolytic capacitor (i.e. a system comprising at least two electrodes in aluminium, an electrolyte and at least one separator).

### GENERAL PRESENTATION OF THE PRIOR ART

Different types of supercapacitors are known. These supercapacitors are intended to be connected to each other to form modules for the following reasons.

Two different unit supercapacitor structures, having a unit voltage generally of less than 3.0 V and operating in an organic medium, are generally used:
cylindrical supercapacitors made from the simultaneous coiling of 2 electrodes and 2 separators;
prismatic supercapacitors made from successive stacked layers to form a stacked element known as a stack. In this case, two assemblies of electrodes are formed: one for the positive electrode and the other for the negative.

In general, the design of cylindrical supercapacitors allows an electrical energy storage assembly to be obtained whose series resistance is lower than that of prismatic supercapacitors: current collection is at times obtained directly by laser welding on the coil as described in document EP1964138, which allows a considerable reduction in contact electrical resistance.

However cylindrical supercapacitors have a disadvantage: the energy density of the modules obtained by electrically connecting several cylindrical supercapacitors is lower than the energy density of the modules obtained with the electrical connecting of several prismatic supercapacitors. Modules with cylindrical supercapacitors are less compact than modules with prismatic supercapacitors due to the presence of a dead volume between two adjacent cylindrical supercapacitors.

Yet a module forms the basic unit of applications. A unit supercapacitor effectively cannot be used alone due to its low voltage (in general 2.7 V or 2.8 V). The advantage of a prismatic supercapacitor is its volumetric energy density.

However the series resistance of prismatic supercapacitors is generally much higher than that of cylindrical supercapacitors on account of the type of current collection which is obtained by a screwed mounting, hence costly in terms of labour and parts.

This strong series resistance is the major drawback of the technology since it involves very strong heating (Joule effect) which leads to accelerated ageing of modules.

Appended Table II gives the values of volumetric and gravimetric energy densities:
first of a prismatic supercapacitor and of a module containing this prismatic supercapacitor;
and secondly of a cylindrical supercapacitor and of a module containing this cylindrical supercapacitor.

It is ascertained in Table I that the series resistance of a module containing prismatic supercapacitors is 25% higher than that of a module containing cylindrical supercapacitors. It is also ascertained that the gravimetric energy density of a module containing prismatic supercapacitors is 25% higher than that of a module containing cylindrical supercapacitors.

Table I also shows that prismatic supercapacitors, on account of their complex mounting, generally have a higher number of parts than a cylindrical supercapacitor.

Problems inherent in the module assembling of prismatic supercapacitors are therefore the additional number of parts (packing, heat sink, . . . ), labour-intensive process, large weight contribution of inactive components (generally at least 50% of total weight). Finally, component assembly requires the use of welding to join components via bars. To withstand vibration tests, it is therefore important to form a robust structure, and hence most generally a solid structure.

Cylindrical and prismatic supercapacitors therefore each have advantages and disadvantages.

Whether cylindrical or prismatic, the voltage of supercapacitors working in an organic electrolytic medium—such as TEABF₄ in acetonitrile—is limited to around 6 V for organic electrolytes and in the region of I V for aqueous electrolytes (Ref: “Electrochemical Properties of Organic Liquid Electrolytes Based on Quaternary Onium Salts for Electrical Double-Layer Capacitors” Makoto Ue, Kazuhiko Ida and Schoichiro Mori, J. Electrochem. Soc. Vol. 141, N^{o} 11, 1994).

Over and above this voltage total degradation is observed of the electrolyte (solvent and salt). In addition, the higher the operating voltage of a supercapacitor the faster the degradation of the electrolyte, and hence the shorter the lifespan of the supercapacitor.

On this account, manufacturers of supercapacitors produce supercapacitors whose nominal voltage is limited to 2.7 V, even 2.8 V, for organic electrolytes. This voltage is a trade-off between lifetime and energy performance level of the supercapacitor.

The energy of a supercapacitor is directly related to voltage via the formula:

E=½C·U²
where E is the energy of the supercapacitor, C is the capacitance of the supercapacitor and U is the voltage of the supercapacitor.

A unit supercapacitor therefore has a low operating voltage. This is why a unit supercapacitor cannot be used alone in the vast majority of applications.

As recalled above, supercapacitors are therefore generally assembled to form a module operating at a high voltage—the operating voltage of the module being equal to the sum of the nominal voltages of the supercapacitors when mounted in series. In general, the sizing of applications lays down minimum and maximum operating voltages and required energy. From these parameters is determined the number of necessary components to obtain the voltage and total capacitance of the module. As a result, the unit capacitance of each component is calculated, then each supercapacitor is sized in relation thereto. However, depending upon applications, the parameters of voltage and energy and therefore the sizing of the supercapacitor vary. This raises a major disadvantage for the manufacturer who is unable to use one same supercapacitor irrespective of the application.

It is one objective of the present invention to propose a prismatic supercapacitor whose operating voltage is higher than that of existing prismatic supercapacitors, to allow the production of modules operating under high voltage.

A further objective of the invention is to propose a prismatic supercapacitor whose series resistance is lower than that of existing prismatic supercapacitors.

### DISCLOSURE OF THE INVENTION

For this purpose an electrical energy storage assembly is proposed, comprising:
at least three stacked complexes, each comprising at least one electrode;
at least one separator, the separator(s) being arranged so that the separator or at least one separator is arranged between each pair of adjacent complexes;
two connection terminals for the electrical connection of the assembly to a voltage generator, a first sample of complexes being electrically connected to or forming one of the two terminals and a second sample of complexes being electrically connected to or forming the other of the two terminals, the two samples being chosen so that the number of complexes belonging to the combining of the two samples is less than the total number of complexes and so that the intersection of the two samples is a void assembly.

In the present invention by “stacked complexes” is meant complexes at least partly superimposed over each other. It is noted that complexes wound together in coils to obtain a coiled element are not considered to be stacked complexes in the meaning of the present invention.

For example, each of the complexes located at one end of the stack is connected to or forms one of the connection terminals, each particularly being connected to or forming a separate connection terminal. Said storage assembly in fact comprises at least one separate complex connected to each respective terminal of the assembly, and at least one complex which is not connected to any terminal of the assembly and whose potential is therefore not imposed by one of these terminals.

Said energy storage assembly can withstand a higher voltage than a prior art assembly. In the assembly of the invention only some of the complexes, each forming a terminal of two adjacent unit elements (each unit element being formed by two complexes and forming a capacitor, a supercapacitor or a battery), are connected to an external generator. The other complexes are arranged in “floating” manner i.e. not connected to the outside.

The unit elements of the assembly behave as if they were in series. Therefore, when the complexes electrically connected to the outside of the assembly are well chosen, for example they are positioned at the ends of the stack, the voltage of the external generator is not delivered to each unit element as is the case in the state of the art, but to a set of unit elements in series i.e. those located between the two complexes connected to the outside. The unit voltage applied to each unit element is therefore equal to the voltage applied to the terminals of the assembly divided by the number of unit elements between the two connected complexes.

It is therefore possible to prevent degradation of the electrolyte, irrespective of the voltage applied to the terminals of the assembly, if the number of unit elements is wisely chosen so that the local voltage is sufficiently low to avoid electrolyte degradation. On this account, by means of the invention, it is easy to create an energy storage assembly that operates reliably even if subjected to a high voltage. Said assembly is additionally of simple design, reduced size and obviates the need for interconnects such as bars or balancing circuitry, which allows a reduction in the manufacturing costs of the assembly.

It also allows a module to be obtained of large capacitance and low resistance. Since each assembly operates at the voltage it is desired to apply to the application, it is possible to arrange different assemblies in parallel and not in series, which makes it possible to add together the capacitances of the different assemblies and not to obtain a total capacitance of the assemblies that is lower than the capacitance of each assembly as is the case when the assemblies are connected in series. On the other hand, due to this assembly in parallel, the total resistance of the assemblies is lower than the resistance of each assembly, which is advantageous in particular to prevent over-heating of the module.

Therefore, with the assembly of the invention it is possible to obtain supercapacitors having good electrical properties whilst being low-cost and simple to produce. The electrical energy storage assembly may also comprise a housing intended to receive the stack formed of complexes and of the separator or separators, the housing containing an electrolyte for impregnation of the complexes. This housing is advantageously formed of a single compartment. Therefore the complexes are not each placed in a respective compartment but are placed in one single compartment.

Preferred but non-limiting aspects of the energy storage assembly of the invention are the following:
the assembly comprises at least one complex including a current collector;
the assembly also comprises two opposite electrodes either side of the current collector. One of the two electrodes may be of greater thickness than the other of the electrodes. The two electrodes may also be of different composition. This allows optimization of the properties of the assembly;
at least one, preferably each, complex located at one end of the stack is formed of a current collector and of a single electrode on its surface facing the remainder of the stack;
the structure of the assembly is such that:
   the separator extends accordion-wise and comprises a plurality of sections, two adjacent sections being connected at a fold-line to form a fold having a concave side and a convex side;
   at least one of the complexes forming a first complex extending chevron-wise and being positioned on a first face of the separator, each first complex being folded along a fold-line and being arranged on a respective convex side of the first face of the separator so that the fold-line of each first complex coincides with a respective fold-line of the separator;
   at least one other of the complexes forming a second complex extending chevron-wise and being positioned on a second face of the separator, each second complex being folded along a fold-line and being arranged on a respective convex side of the second face of the separator so that the fold-line of each second complex coincides with a respective fold-line of the separator;
the assembly may then comprise a plurality of first complexes on the first face of the separator, the first complexes being positioned on every other convex side, and a plurality of second complexes on the second face of the separator, the second complexes being positioned on every other convex side;
the fold-lines of the separator may form the sides of the stack, one section of a first complex forming the top of the stack and one section of a second complex forming the underside of the stack;
the assembly comprises at least one measuring terminal to measure the voltage between a connection terminal and the measuring terminal, one complex belonging neither to the first nor to the second sample but being connected to or forming the measuring terminal;
in one embodiment, the assembly further comprises a housing intended to receive the stack, and two lids intended to cap the housing and forming connection terminals of the assembly, the complex located at one end of the stack belonging to the first sample and being electrically connected to the first lid, preferably over its entire surface, and the complex located at the other end of the stack belonging to the second sample and being electrically connected to the second lid, preferably over the entire surface thereof;
in another embodiment, the housing is made in a flexible material, the complexes belonging to the first and second samples comprising a portion formed in particular of a portion of the collector extending outside the flexible housing, so that the portions of the complexes of one same sample form a connection terminal of the assembly;
at least one separator is in one piece with a complex, preferably a folded separator is in one piece with a complex so as to cover the two opposite faces of this complex;
the assembly comprises an organic electrolyte such as tetraethylammonium difluoromono(1,2-oxalato(2-)-o,o′]borat(1-), (or TEABF₂Ox), the number of complexes and the distribution of the complexes of the first and second samples being chosen so that the local voltage between every pair of adjacent complexes of the assembly is less than 6 V, preferably 3 V.
the assembly comprises an aqueous electrolyte such as potash, sodium hydroxide, sulfuric acid, sodium nitrate, sodium sulfate, lithium nitrate, lithium sulfate, the number of complexes and the distribution of the complexes of the first and second samples being chosen so that the voltage between every pair of adjacent complexes of the assembly is less than 2 V, preferably 1 V.

The invention also concerns a module comprising a casing comprising at least one assembly of the invention.

Preferred but non-limiting aspects of the module of the invention are the following:
the module comprises a plurality of assemblies, said assemblies being electrically connected in parallel;
each assembly comprising first and second connection terminals projecting from a flexible housing containing a stack, the assemblies being superimposed and attached together to form a block, the assemblies being arranged so that the first connection terminals are electrically connected together, in particular via a first metal plate, and the second connection terminals are electrically connected together in particular via a second metal plate;
the connection terminals of the assemblies are laid flat and assembled directly onto the metal plates;
the metal plates comprise grooves;
each metal plate comprises a pin, preferably positioned in the centre of the plate, the pins allowing the electrical connection of the module to an external electrical member;
at least one interstice is provided between two adjacent assemblies.

### PRESENTATION OF THE FIGURES

Other characteristics, objectives and advantages of the present invention will become apparent from the following description which is purely illustrative and non-limiting and is to be read with reference to the appended drawings in which:

FIGS. 1, 2, 3, 4a, 4b, 5, 6a, 6b, 7a, 7b, 7c, 8 and 9 schematically illustrate different embodiments of an energy storage assembly according to the invention;

FIG. 10 schematically illustrates a module core using assemblies formed of prior art cylindrical supercapacitors;

FIGS. 11 to 16 illustrate different embodiments of a module using assemblies of the invention.

### DESCRIPTION OF THE INVENTION

For better understanding of the invention, the operating principle of a supercapacitor will briefly be recalled.

### Operating Principle of Supercapacitors

A supercapacitor is conventionally formed of two complexes 1, 2, of a separator 3 between the two complexes 1,2 and of an electrolyte.

The separator 3 is made of electrically insulating material.

The electrolyte may be an aqueous medium or an organic medium. In all cases, the electrolyte comprises ions and is electrically conductive. One pertinent example of an electrolyte is tetraethylammonium difluoromono[1,2-oxalato(2-)-o,o′]borat(1-), (or [TEABF₂Ox]).

Each complex 1, 2 comprises a current collector 11, 21 and at least one electrode 12, 13, 22, 23.

Each electrode 12, 13, 22, 23 is made from activated carbon, a conductive additive and one (or more) polymers to bind the two preceding constituents. This electrode 12, 13, 22, 23 is then coated or extruded on the current collector 11, 21. It forms the active material of the complex 1, 2.

The constituent material of the current collector 11, 21 is aluminium, nickel, copper or stainless steel for example. The material of the current collector 11, 21 is chosen for its chemical and electrochemical inertia against the constituents of the electrode 12, 13, 22 and 23 of the electrolyte.

The distance between the electrodes 12, 22, 13, 23 is generally in the order of a few tens of micrometres (in general between 15 and 45 μm) i.e. more than 10,000 times greater than the size of the ions. This can guarantee that an ion is therefore unable to be in contact simultaneously with the two electrodes 12, 22, 13, 23.

In a supercapacitor, electrical energy storage is obtained by movement of ions within the porosity of the activated carbon forming the electrodes. The size of the ions is in the order of 0.3 to 0.7 nm ([B. E. Conway, R. E. Verall, J. E. Desnoyers, Trans. Faraday Soc. 62, pp 2738-2744, 1966]-[R. A. Robinson, R. H. Stokes, Electrolyte Solutions, 2^{nd} Edition, Butterworths, London, 1965]-[W. G. Pell, B. E. Conway, N. Marincic, J. Electroanal. Chemistry 491, pp 9-21, 2000]-[M. Endo, Y. J. Kim, H. Ohta, K. Ishii, T. Inoue, T. Hayashi, Y. Nishimura, T. Maeda, M. S. Dresselhaus, Carbon 40, pp 2613-2626, 2002]).

When a voltage is applied to the terminals of a supercapacitor it generates an electric field. Under the effect of this electric and electrostatic field, the positive ions (e.g. TEA⁺) will preferably move towards the negative electrode and the negative ions (e.g. BF₄⁻) will move towards the positive electrode.

Therefore, the total equivalent capacitance of the component is (C⁺×C⁻)/(C⁺+C⁻). If C⁺ and C⁻ are of same order, the total equivalent capacitance is C/2.

Total degradation of the electrolyte only occurs as from the time the voltage between the two electrodes of opposite signs is in the order of 6 V for organic electrolytes and in the order of 1 V for aqueous electrolytes. By strongly limiting the voltage between the electrodes of opposite signs, the ageing of the supercapacitor is limited.

It is one objective of the invention to allow an increase in voltage at the terminals of a supercapacitor without accelerating the ageing thereof.

One solution to this problem is to form a supercapacitor comprising a stack of electrodes 12, 22, 13, 23 of opposite signs, of which only the electrodes positioned at the ends of the stack are electrically connected to the outside of the supercapacitor. The other electrodes of the supercapacitor are therefore in “floating” position i.e. not connected to the outside.

### Description of the Supercapacitor According to the Invention

A description will now be given of different embodiments of the storage assembly according to the invention with reference to the Figures. In these different Figures, equivalent parts of the storage assembly carry the same reference numbers.

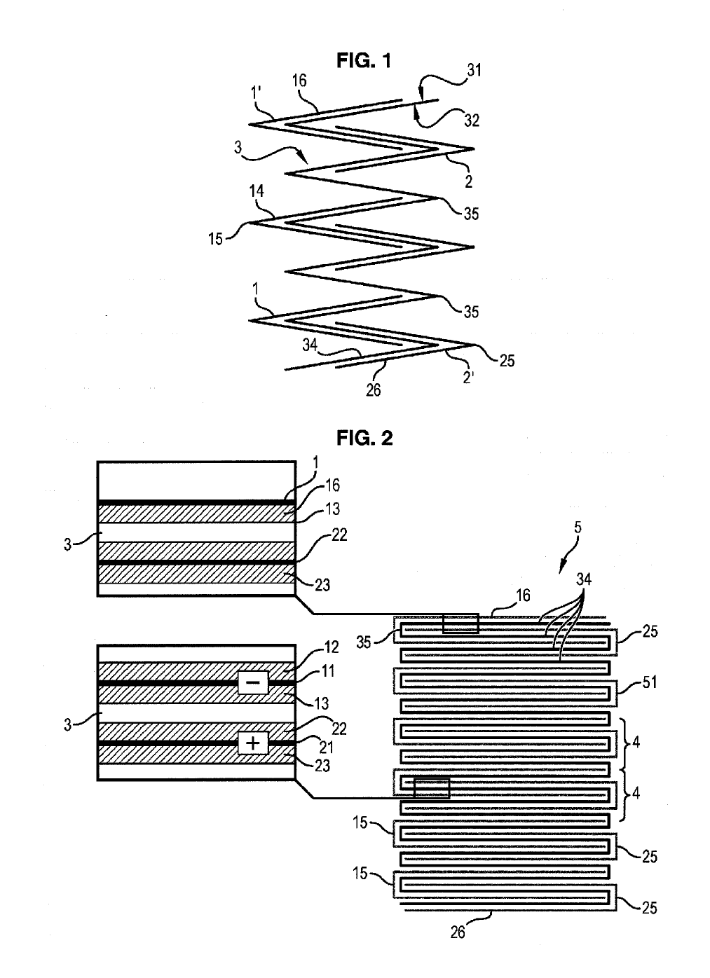

With reference to FIGS. 1 to 3, the storage assembly comprises:
a separator 3 having two faces 31, 32: a first face 31 and a second face 32 opposite the first face 31;
a plurality of first complexes 1 arranged on the first face 31 of the separator 3; and
a plurality of second complexes 2 arranged on the second face 32 of the separator 3.

The separator 3 is in electrically insulating material. The separator 3 extends between the first and second complexes 1, 2. It ensures electrical insulation between the first complexes 1 and second complexes 2.

In the embodiment illustrated in FIG. 2, each complex 1, 2 comprises a substantially planar current collector 11, 21 and two opposite electrodes 12, 13 and 22, 23 either side of the current collector 11, 21. Each electrode 12, 13 and 22, 23 has one electrically conductive face in common with a respective face of the current collector 11, 21. Therefore, each face of one complex 1, 2 comprises a respective electrode: this makes it possible to increase the energy density of the supercapacitor.

The structure of the supercapacitor in FIGS. 1 to 3 is the following.

The separator 3 extends accordion-wise: it comprises at least three sections 34, two adjacent sections being connected at a fold-line 35 to form a fold having a concave side and a convex side.

Each first complex 1 extends chevron-wise: it comprises two single sections 14 connected along a fold-line 15 to form a complex fold having a concave side and a convex side. The concave side of each first complex 1 is intended to come and lie opposite a respective convex side of the first face 31 of the separator 3.

Similarly, each second complex 2 extends chevron-wise and has a concave side and a convex side. Here again, the concave side of each second complex 2 is intended to come and lie opposite a respective convex side of the second face 32 of the separator 3.

Each first complex 1 faces a second complex 2 to form a unit element 4. The first and second complexes of a unit element 4 are offset from each other by a section 34 of separator 3. In other words, each first complex 1 is folded along a fold-line 15 and is arranged on a respective convex side of the first face 31 of the separator 3 so that the fold-line 15 of each first complex 1 coincides with a respective fold-line 35 of the separator 3. Similarly, each second complex 2 is folded along a fold-line 25 and is arranged on a respective convex side of the second face 32 of the separator 3 so that the fold-line 25 of each second complex 2 coincides with a respective fold-line 35 of the separator.

The final supercapacitor may be formed of several unit elements 4 arranged in series and separated two by two by a separator section to form a stack 5.

The fold-lines 35 of the separator 3 form the sides 51 of the stack 5. A section 16 of a first complex 1′ is located at a first end of the stack so as to form the top of the stack 5 and a section 26 of a second complex 2′ is located at a second end of the stack so as to form the underside of the stack 5.

The first complex 1′ located at the first end of the stack 5 is intended to be electrically connected to (or to form) a first connection terminal of the storage assembly. The second complex 2′ located at the second end of the stack 5 is intended to be electrically connect to (or to form) a second connection terminal of the storage assembly.

The first complex 1′ forms a first sample of complexes. The second complex 2′ forms a second sample of complexes. In the present invention by “first sample of complexes” (respectively “second sample of complexes”) is meant a group of complexes intended to be electrically connected to (or to form) the first (respectively second) connection terminal of the storage assembly.

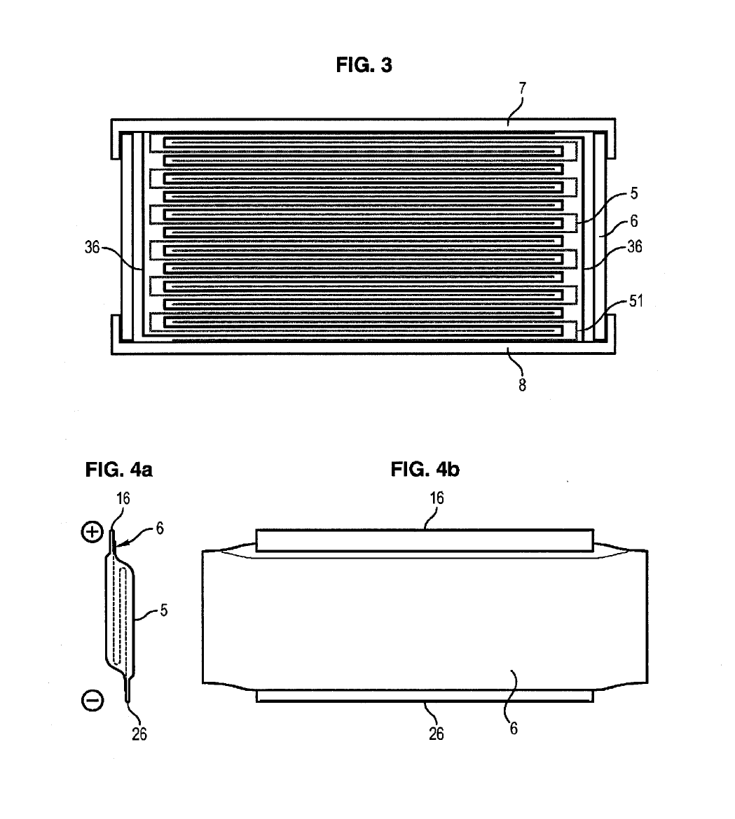

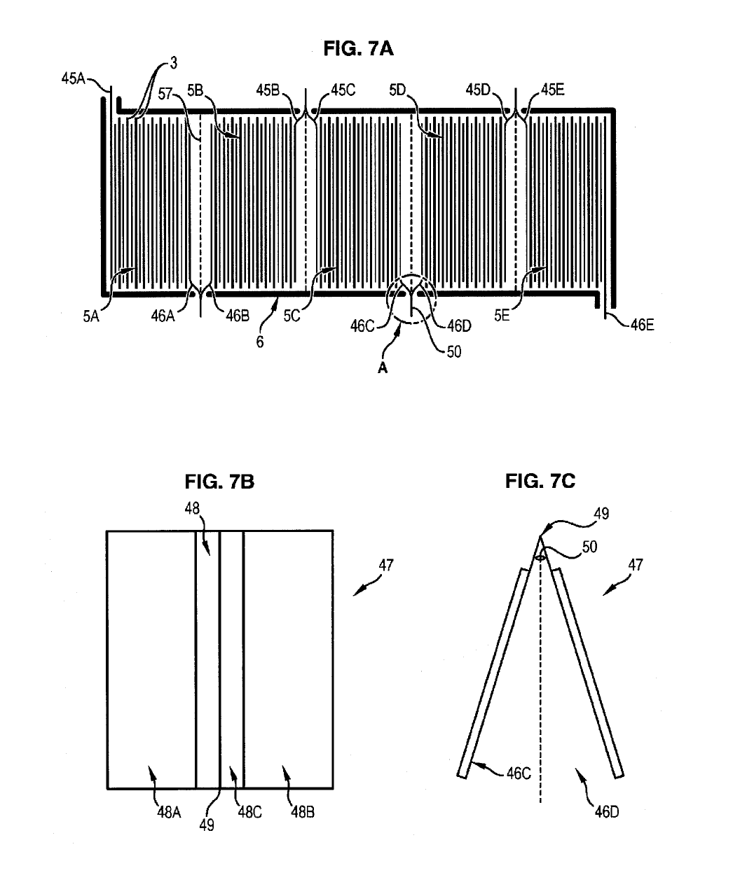

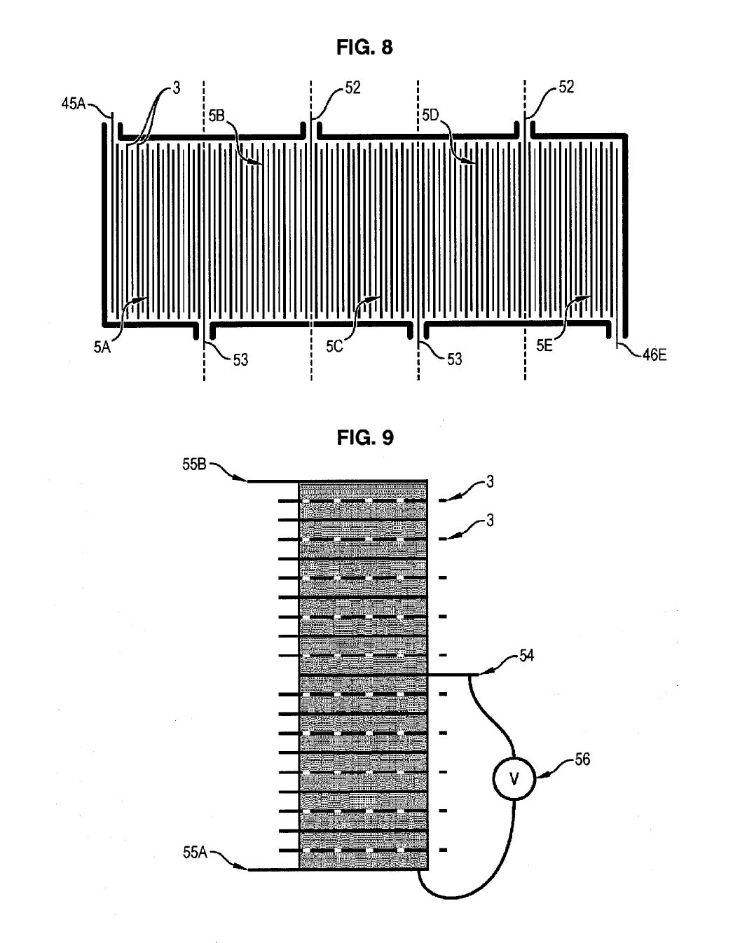

In the embodiment illustrated in FIGS. 1 to 3, each sample of complexes comprises a single complex. However, each sample of complexes may comprise several complexes. For example, with reference to FIGS. 7 and 8, each sample of complexes comprises a plurality of complexes, e.g. 5 in the embodiment in FIGS. 7 and 3 in the embodiment in FIG. 8.

The reader will appreciate that the number of complexes belonging to the combining of the two samples is less than the total number of complexes and the intersection of the two samples is a void assembly.

In other words:
at least one complex of the storage assembly belongs neither to the first nor to the second sample of complexes (i.e. the number of complexes belonging to the combining of the two samples is lower than the total number of complexes); and
a complex belonging to the first sample of complexes cannot belong to the second sample of complexes (i.e. the intersection of the two samples is a void assembly).

This means:
firstly, that the stack 5 comprises at least one complex which is not electrically connected either to the first terminal or to the second terminal of the storage assembly; and
secondly, that a complex connected to the first (respectively second) terminal of the storage assembly cannot be connected to the second (respectively first) terminal.

The stack 5 is arranged in a housing 6 illustrated in FIG. 3. The housing is formed of a single compartment intended to receive all the complexes. This housing contains an electrolyte which impregnates all the elements of the stack.

This housing 6 may be rigid and of parallelepiped shape for example, as illustrated in FIG. 3. In this case, upper and lower lids 7, 8 are used to cap the housing 6. The stack 5 is also impregnated with an organic or aqueous medium forming the electrolyte of the supercapacitor. The section 16 of the first complex 1′ forming the top of the stacked element 5 is electrically connected to the upper lid 7 over the entire surface thereof. The section 26 of the second complex 2′ forming the underside of the stacked element 5 is electrically connected to the lower lid 8 over the entire surface thereof. If a collector 11, 21 in aluminium is used, the upper lid 7 (respectively lower lid 8) of the supercapacitor can be directly welded, brazed or diffusion-bonded with gallium over the entire surface of the section 16 (respectively 26) of the first complex 1′ (respectively second 2′ complex) forming the top (respectively underside) of the stack 5. This allows maximization of the contact surface between each lid 7, 8 and the stacked element 5 and hence minimization of the electrical resistance of the supercapacitor. The lids 7, 8 form the connection terminals of the supercapacitor.

The fact that only two complexes 1′, 2′ of the stacked element 5 project beyond the separator 3 and are electrically connected to the upper and lower lids 7,8, the other complexes “floating”, means that it is possible to reduce the risks of short-circuiting between the different complexes 1, 2 of the stacked element 5, and more especially to apply a high voltage to the terminals of the supercapacitor without degrading the electrolyte however, as explained above.

Advantageously the separator 3 can be designed sufficiently long so that the end portions 36 thereof are folded over such that they overlap the sides of the stack 5 comprising the fold-lines 35, to cover (or hoop wrap) the stacked element 5 as can be seen in FIG. 3.

In some embodiments, the section 16 of the first complex 1′ forming the top of the stack 5 does not have any electrode on its surface facing the lid 7. This firstly allows the facilitated electrical connection of the upper lid 7 to the first complex 1′ forming the top of the stacked element 5, and secondly a reduction in the electrical resistance between the lid 7 and the complex 1′. Similarly, the section 26 of the second complex 2′ forming the underside of the stack 5 can be devoid of any electrode on its surface facing the second lid 8.

One advantage of the structure of the supercapacitor illustrated in FIGS. 1 to 3 is the use of a single separator 3. This allows simplification of the manufacturing process of the supercapacitor. In addition, the use of a single separator 3 allows the preventing of short-circuits between electrodes and facilitates packing (i.e. adjustment) between opposite-facing electrodes. Finally, the use of a single separator 3 allows the mechanical strength of the supercapacitor to be increased, the separator 3 forming the backbone of the supercapacitor and imparting some rigidity thereto.

The structure of the prismatic supercapacitor of the invention allows the voltage to be varied at the terminals of the supercapacitor in relation to the number of constituent electrodes of the stacked element 5 of the supercapacitor as explained above.

In addition, the structure of the prismatic supercapacitor prevents the creation of any parasitic induced current, since the supercapacitors produced are not coiled contrary to cylindrical supercapacitors.

The use of supercapacitors according to the invention in modules also allows elimination of the balancing circuitry of the module. The working voltage between two unit electrodes of the supercapacitor can be chosen to be sufficiently low to prevent ageing. For example, it can be chosen to maintain a voltage of 2.3 V between two opposite-facing electrodes of the supercapacitor. On this account, gas generation is very strongly limited and the fabrication of the module does not require any very rigid component to withstand an increase in internal pressure.

Since the supercapacitor can be sized so that the voltage between its terminals is equal to the desired voltage in the intended application, it is possible to fabricate modules in which the supercapacitors are mounted in parallel, which is highly advantageous both for the capacitance and total resistance of the module.

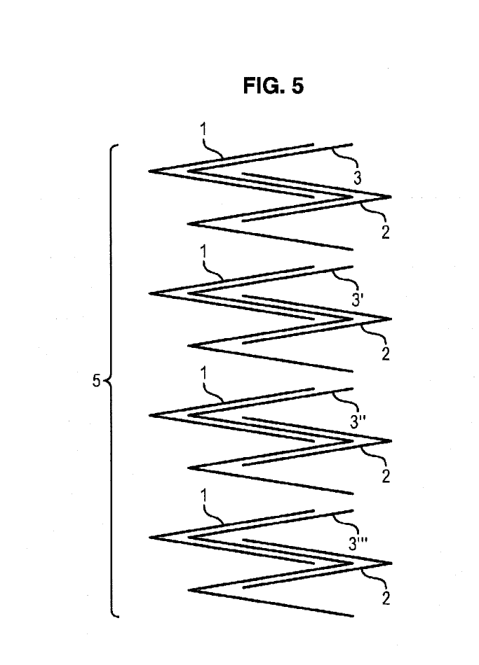

FIGS. 4a and 4b illustrate another embodiment of the supercapacitor of the invention. In this embodiment, the housing 6 containing the stack 5 is made in a gas-tight and electrolyte-tight flexible material.

For example, the housing 6 may be formed of one (or more) heat-sealable sheets (whether or not with foil laminate) and whether or not folded over. The detailed characteristics of said housing are notably described in document U.S. Pat. No. 4,092,464. Said housing is already given industrial use in particular to receive lithium-ion and lithium-polymer batteries dedicated to portable applications (mobile telephones, PDAs, GPS, etc.).

Advantageously, one portion of the section 16 of the first complex 1′ forming the top of the stacked element 5 projects outside the housing 6. This portion of the section 16 acts as first electrical connection terminal to the supercapacitor. Similarly, one portion of the section 26 of the second complex 2′ forming the underside of the stacked element 5 projects outside the housing 6.

This portion 26 acts as second electrical connection terminal to the supercapacitor. These connection terminals are used for example to connect the supercapacitor electrically to another supercapacitor.

In this embodiment the sections 16, 26 of the first and second complexes 1′, 2′, forming the top and underside of the stacked element 5, comprise a single electrode positioned facing the remainder of the stack, in particular facing the adjacent electrode. In addition the collector of each section 16, 26, is extended so as to project from the housing 6, the portion of the collector projecting from the housing being devoid of any electrode.

In the embodiment illustrated in FIGS. 4a and 4b, the connection terminals 16, 26 are positioned on two opposite sides of the housing 6. The person skilled in the art will have understood that these connection terminals 16, 26 may extend over the same side of the housing 6 or over adjacent sides of the housing 6 and can extend the housing in its length or width.

FIG. 5 illustrates a variant of embodiment of the supercapacitor of the invention. In this variant the supercapacitor comprises several separators 3, 3′, 3″, 3″′.

As in the embodiment illustrated in FIGS. 1 to 3, each separator 3, 3′, 3″, 3′″ is folded accordion-wise, and on each of its faces comprises first and second complexes 1, 2, each complex 1, 2 being folded chevron-wise. The first and second complexes 1, 2 associated with each separator 3, 3′, 3″, 3′″ are offset from each other by a pitch equal to a section of separator 3, 3′, 3″, 3″′.

The different separators 3, 3′, 3″, 3′″ and their associated complexes 1, 2 are stacked on each other to form the stack 5. This embodiment with separators of finite length allows a stacked element to be formed irrespective of its desired height.

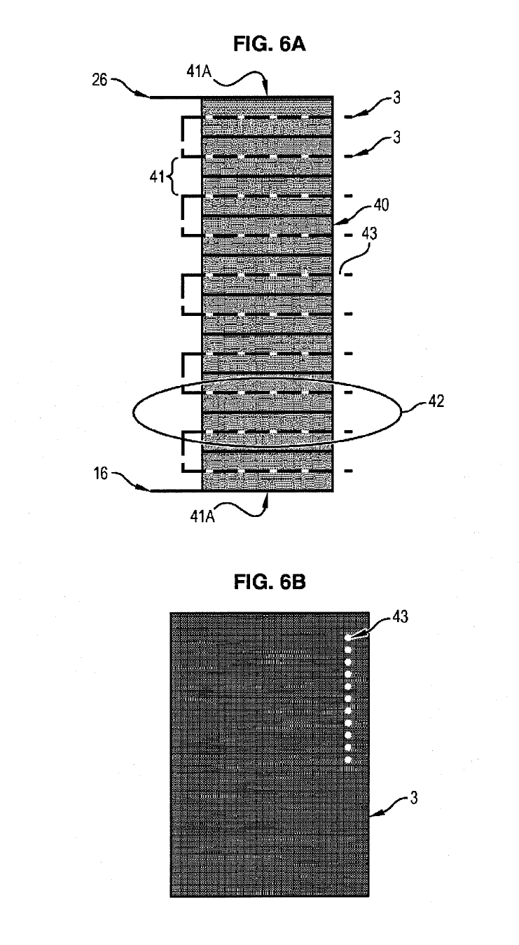

In a third embodiment, illustrated in FIG. 6a, each separator is in one piece with a complex. The separator 3 is more specifically folded over a complex 40 so as to cover the two opposite faces of this complex. The stack then consists of alternate complexes 40 comprising an integrated separator 3 and complexes 41 devoid of separators.

### Fabrication of an Assembly of the Invention

A description will now be given of a method for assembling an assembly according to the third embodiment of the invention.

The fabrication of said assembly can be conducted using the following steps:
folding the separator 3 over the complex 40;
assembling the folded separator containing the complex (electrode/collector/electrode) by rolling or calendering to form an element 42 in a single piece. To facilitate assembling, the separator can be perforated with orifices 43 as illustrated in FIGS. 6A and 6B, or re-melted locally at the time of assembly using hot needles, if it is made of a polymer material;
reconstituting a stack by superimposing a complex without separator 41 alternately over a complex with separator 40. The complexes forming the ends of the stack are preferably complexes without separator 41A. They are also single-sided and form the connection terminals of the assembly as explained above;
compacting the stack;
placing the stack in a flexible housing or in a rigid plastic casing comprising a lid;
closing the housing on at least 2 sides, or sealing the lid. Closure is preferably partial so that the electrodes project outside the housing to guarantee an improved seal.

### Variants of Embodiment of an Assembly of the Invention

A description will now be given of variants of embodiment of the invention.

In this invention, it will be noted that the assembly does not necessarily comprise two-faced complexes (i.e. the complex comprises a current collector and two opposite electrodes either side of the collector). All the complexes of the module can be single-sided on a collector (i.e. the complex comprises a current collector and one electrode on one of the faces of the collector) or more advantageously at least some complexes may be self-supporting (i.e. the complex solely comprises one electrode and does not comprise any current collector) as described for example in patents FR 2871615 and FR2759087. In this case, the stacked complexes and the energy density are increased compared with the component comprising a collector. This solution is also economically advantageous since it allows substantial limitation of the use of a collector, this being an expensive constituent in supercapacitors, and the use of one same complex for supercapacitors operating in an organic medium or aqueous medium for which the collectors usually used are not the same.

The complexes and the separators may evidently be of simpler design than the description given, each being planar.

It will also be noted as shown in FIGS. 7 and 8 than an assembly may comprise a first sample of several complexes 45A to 45E forming a first connection terminal and/or a second sample of several complexes 46A to 46E forming a second connection terminal, provided that the intersection of the samples is evidently a void assembly and the number of complexes in the combining of the samples is lower than the total number of complexes. This in fact amounts to placing several stacks 5A to 5E such as described above in one same housing 6. All that is required is to cause the projection outside the sealed housing of only those complexes 45, 46 belonging to the first and second samples.

It is then possible as illustrated in FIG. 7a to place the stacks so that two complexes belonging to the same sample are adjacent.

As illustrated more clearly in FIGS. 7b and 7c (FIG. 7c giving a detailed view of A in FIG. 7a), it is also possible to design the complexes so that one single element 47 forms two complexes 46C, 46D each forming a connection terminal of two adjacent stacks. Said element 47 comprises a collector 48 provided with two end regions 48A, 48B on which an electrode is deposited on only one face thereof, and a central region 48C without any electrode. This element is twice longer than a complex forming a conventional connection terminal, such as the complexes 45A, 46E forming the ends of the assembly.

Before being placed in the housing 6, the element 47 is folded over along a fold-line 49 extending to the centre thereof so that the first half of the element forms an end complex 46C of a first stack 5C and the second half thereof forms an end complex 46D of an adjacent stack 5D. The region without any electrode then projects outside the housing 6. To ensure the seal of the assembly provided with said complex it is necessary however to add a fusible material 50 between the two halves of the complex, for example when heat sealing the casing. This material is placed on the surface opposite the surface on which the electrode has been deposited.

It will also be noted that a sheet of sealing material 57 such as the one forming the housing can be placed in the housing between two stacks. The presence of such sheet is optional however.

One means of simplifying an assembly comprising several stacks is to form an assembly such as described in FIG. 8. Double-sided complexes 52, 53 are then used, forming both the end complex of a first stack, respectively 5A and 5C for complexes 53, and 5B, 5D for complexes 52, and the end complex of a second adjacent stack, respectively 5B and 5D for complexes 53, and 5C, 5E for complexes 52. The collector of such complex 52, 53 comprises a projecting portion protruding from the housing. In this case, the housing is sealed with no leakage problem. In the case shown FIG. 8, the first sample is formed of complexes 45A and 52, and the second sample is formed of complexes 53 and 46E.

As illustrated in FIG. 9, it is also possible in all the cited embodiments, to design the assembly so that it comprises at least one measuring terminal 54 in addition to the connection terminals 55A, 55B (here respectively formed by each of the end complexes of the stack). A complex belonging neither to the first nor to the second sample and hence separate from the end complexes is connected to the measuring terminal. This makes it possible to perform voltage measurements using a voltmeter 56 in each part of the stack to determine at least in part the distribution of voltage therein. Quite simply, this measuring terminal can be created for example by adding a collector portion extending an intermediate complex of the stack towards the outside. In this case, the voltage can easily be measured and it is possible to determine whether there is early ageing or a defect within the stack.

In one variant of embodiment, the thicknesses of the electrodes deposited on the two faces of the collector are different. If an electrolyte is used whose cation is more voluminous than the anion (diameter of the ion), the negative electrode is preferably chosen to be the thinnest to limit ageing. It is possible however to choose a thicker negative electrode with a view to increasing energy density. This choice is made however to the detriment of ageing.

In another embodiment, the assembly comprises complexes with a collector and battery electrodes, i.e. electrodes made of different materials and respectively forming the cathode and anode of the battery. In this case, the collector is preferably chosen to form an ion barrier. One first face of the collector comprises one type of electrode (e.g. cathode) and a second face comprises the electrode of opposite polarity (anode). The anode may be formed of metal Lithium for example or graphite or a carbon material or insertion compound (tin, antimony, silicon, sulfur, etc.) whereas the cathode can be in LiFePO₄ for example. The thicknesses of the two electrodes can also be different. This makes it possible to considerably increase the density of the batteries, as in the case of the previously described supercapacitors.

### Measurement of the Characteristics of a Supercapacitor Comprising a Stack According to the Second Embodiment of the Invention

The results in appended Table II were obtained with a supercapacitor of the following type:
Number of stacked sheets: 22 including 20 so-called “double-sided” complexes i.e. comprising a current collector and two electrodes, each electrode being in contact with a respective face of the current collector—and two so-called “single-sided” complexes i.e. comprising a current collector and one single electrode on one face of the current collector—the single-sided complexes forming the top and underside of the stacked element;
Volumetric capacitance of the electrode: 30 F/cm³;
Sheet size: 7 cm×34 cm;
Thickness of single faces: 100 μm of electrode on aluminium collector of thickness 30 μm (total thickness=130 μm)
Thickness of double-faces: 100 μm of recto-verso electrode on aluminium collector of thickness 30 μm (total thickness: 230 μm);
Number of separators: 21;
Separator thickness: 25 μm (TF4425 of NKK)
Electrode volume: 2.38 cm³
Expected theoretical capacitance: 2.38 cm^{3×30} F/cm³/21=3.4 F (electrode volume×volumetric capacitance/number of stacked capacitors (=separator layers)). Measurements were conducted at 54 V in galvanostatic mode 10 A charge/discharge. The voltage between sheets (i.e. for each supercapacitor formed of two successive sheets) was 2.57 V.

It was found that the mean value of the capacitance obtained was very close to the expected theoretical value.

The time constant remained less than one second, which clearly shows the standard behaviour of the supercapacitor thus obtained.

Fabrication of a Module from Supercapacitors of the Invention:

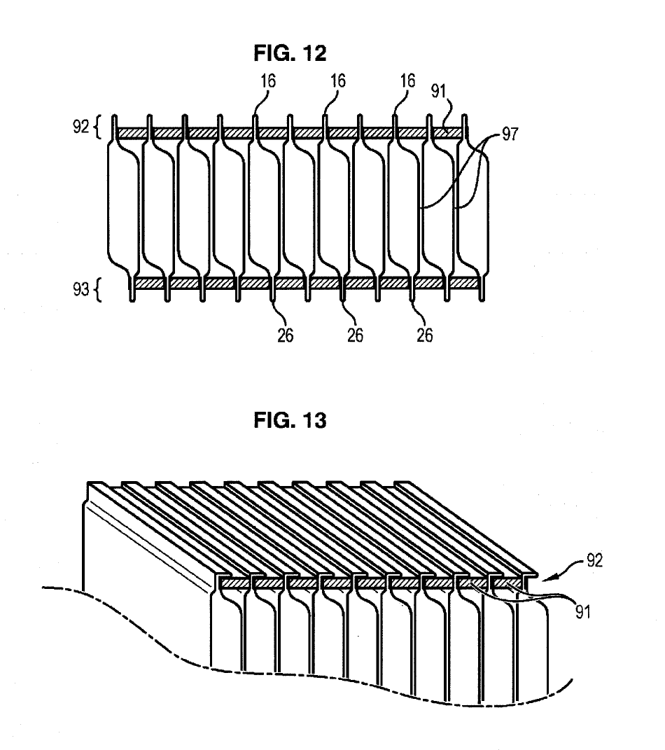

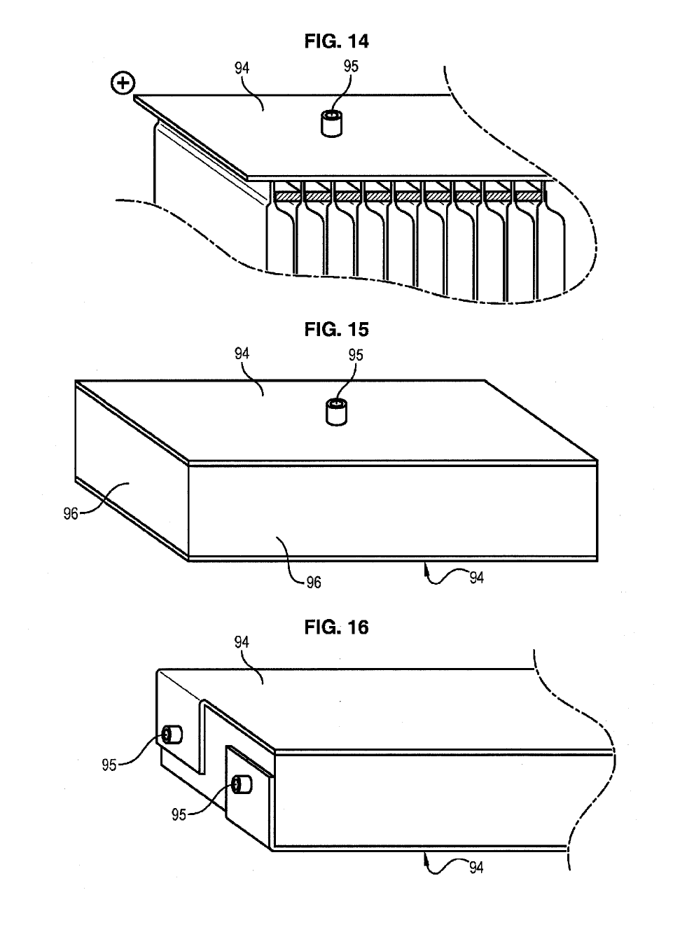

A description will now be given, with reference to FIGS. 11 to 16, of an example of a module obtained by electrically connecting in parallel a plurality of supercapacitors 9 with flexible housing.

Each supercapacitor 9 was composed of a stack 5 comprising two connection terminals 16, 26.

The supercapacitors were arranged so that:
the ends of the connection terminals 16 of positive sign of the different supercapacitors were contained in a first plane P+;
the ends of the connection terminals 26 of negative sign of the different supercapacitors were contained in a second plane P−.

These two planes P+, P− extended either side of the supercapacitors 9. All these connection terminals can be mechanically secured together using glue or resin 91 to form a block as illustrated in FIG. 8.

The “edges” 92, 93 either side of the module thus formed were then joined together to form only two connection pads of the module. The edges 92, 93 can advantageously be of size equal to the size of the connection terminals 16, 26 of the supercapacitors. This makes it possible for the current to be conducted in uniform manner (identical potential over the entire supercapacitor) and also to form an efficient “radiator” for the supercapacitor.

The edges 92, 93 can be laid flat as described in document FR 2 921 195 for the purpose of welding them together as illustrated in FIG. 9. They can also be assembled by brazing as described in document FR 2 902 938, or using any other process allowing low electrical resistance to be obtained.

For the electrical connecting of the edges 92, 93, a metal plate 94 can be welded to (or brazed onto) the edges 92, 93 previously laid flat and assembled, laid flat and non-assembled previously, not laid flat and previously assembled or not previously laid flat and assembled.

By laying the edges 92, 93 flat and assembling the metal plate 94 directly onto the flattened edges it is possible to reduce contact electrical resistance. The metal plate 94 thus assembled also allows heat to be dissipated efficiently towards outside the module. Each plate 94 can be made in aluminium which provides a thermal advantage and may comprise grooves to improve heat dissipation.

The connection to the application can be made via a pin 95 positioned in the centre of the plate 94 to distribute the current uniformly as illustrated in FIG. 15. Each pin 95 can also be offset as per dimensional needs, even brought to the side of the final module as illustrated in FIG. 16.

Verticalisation of the supercapacitors facilitates dissipation of the heat produced during module charging/discharging: vertical supercapacitors therefore act as thermal “radiator”.

The supercapacitors can be placed directly side by side. It is also possible to position interstices 97 between the supercapacitors. These interstices 97 can be formed of a rigid material for mechanical reinforcement of the module. These interstices can also be formed of a polymer material (e.g. of gad pad type) to improve heat dissipation performance.

It is also possible to insert mould the entire module obtained (as is the case for electric motors for example). This makes it possible to provide against leaks whilst rigidifying the module.

The sidewalls 96 of the module can be made in plastic material for electrical insulation of the two poles of the module.

The entire module can also be coated with an insulating cladding only leaving the two connection pins 95 of the module protruding to provide against any user or utilization safety problems. This cladding can be flexible or can be formed by insert moulding (e.g. by immersion). Preferably, the thickness of this cladding is sufficiently thin to facilitate heat dissipation.

It can also be contemplated that the protruding portions of the end complexes project not over the height of the module but over its length. In this case, two opposite sidewalls can be conductive whilst the other walls of the modules are insulating.

In another configuration, all the walls of the modules are insulating: each terminal respectively groups together the complexes respectively forming a positive and negative terminal of each assembly, and passes through one or more walls of the module. In this embodiment, it is then possible to position the terminals of the module on the same side.

It will also be noted that if several stacks are placed in a single housing, an assembly may itself form a module which can be used for one of the applications described below.

### Comparison of Module Sizing Methods

To highlight the advantage of the supercapacitor of the invention a comparison will now be made between sizing methods for:
a module using prior art cylindrical supercapacitors;
a module using prismatic supercapacitors of the invention.

It is recalled that one advantage of the invention is to be able to obtain compact, high voltage supercapacitors.

The problem to be solved for any manufacturer of supercapacitors and modules is, within a given volume, to adapt the assembly of supercapacitors of high unit capacitance (generally higher than 500 F) to a voltage set by the application (generally very high compared to the unit voltage which each supercapacitor is able to withstand) and to minimum useful energy.

### Example of Standard Sizing Using Cylindrical Components

Let us assume the following input data:

Umax·_{application}=120V·Umin·_{application}=60 V
Required energy: 200 kJ.

The voltage of the application entails a necessary number of supercapacitors:
if the nominal voltage of each supercapacitor is 2.5 V then the number of supercapacitors to be mounted in series is: 120 V/2.5=48 supercapacitors mounted in series;
if the nominal voltage of each supercapacitor is 2.73 V then the number of supercapacitors to be mounted in series is: 120 V/2.73=44 supercapacitors in series;
if the nominal voltage of each supercapacitor is 3.0 V then the number of supercapacitors to be mounted in series is: 120 V/3.0 V=40 supercapacitors.

The problem of choice facing the manufacturer can immediately be seen: the use of 44 cylindrical supercapacitors appears to be more advantageous than the use of a higher number (48 supercapacitors); however, the use of 44 supercapacitors can only correspond to 4 rows of 11 components, which is not advantageous in terms of volumetric sizing. Sizing based on 40 components appears to be more compact (8 rows of 5 components) but is particular harsh in terms of ageing having regard to the higher voltage applied to the terminals of each supercapacitor.

The required energy determines the sizing of each supercapacitor:

200 kJ=½C((Umax)²−(Umin)²)

200 000×2/(120²−60²)=37.04 F

If each supercapacitor operates at 2.5 V, a unit capacitance of 1778 F is obtained for each supercapacitor.

If each supercapacitor operates at 2.73 V the capacitance is then 1630 F.

If each supercapacitor operates at 3.0 V the capacitance is then 1482 F.

Similarly this generates the development of lids, casings etc. to fabricate these supercapacitors which do not exist in the manufacturer's range. It can easily be seen that for each application the capacitance of the supercapacitor will be different.

In addition, by causing a supercapacitor to work at 2.5 V or 2.3 V even 3.0 V this leads to a considerable change in the components of the electronic balancing circuitry.

It is therefore not economically advantageous, for each application, to modify the unit voltage of the supercapacitor. This unit voltage is therefore an additional constraint having a direct influence on the sizing of the final module. Also the self-discharging of each supercapacitor will not be the same depending on the unit voltage of the supercapacitor (higher voltage loss AU at a set time if the unit voltage U increases).

### Example of Sizing Using Prior Art Supercapacitors of 1852 F Mounted in Series Having Unit Operation at a Voltage of 2.4 V.

The energy is achieved with 50 supercapacitors; this represents a module comprising 5 rows of 10 supercapacitors.

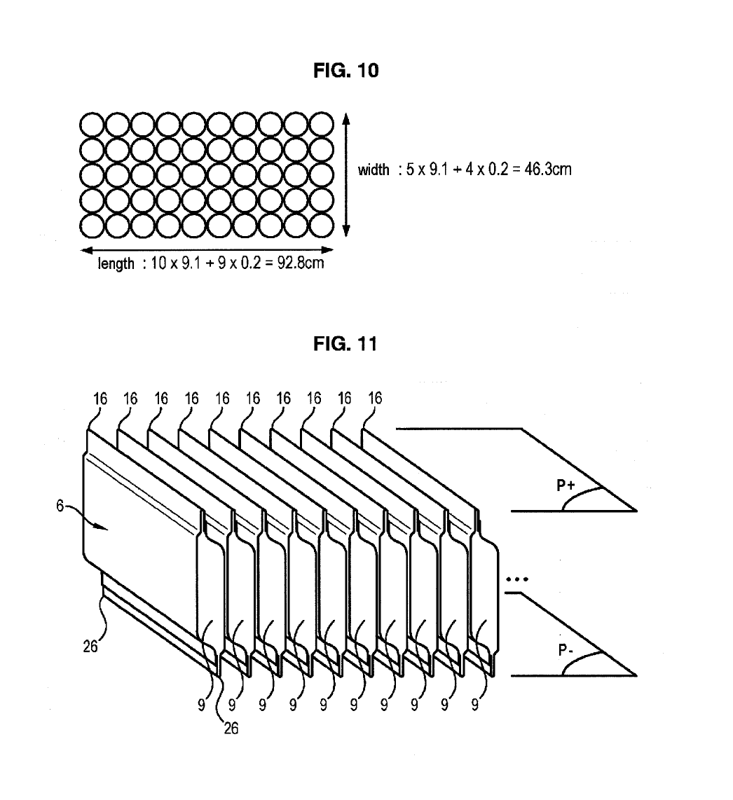

FIG. 10 illustrates the core of a module i.e. the arrangement of the supercapacitors without the module casing and without the electronic management circuit boards—obtained with such sizing.

The diameter of each supercapacitor is 6.2 cm and the height with bar is 11 cm. The capacitance of the electrode is 30 F/cm³. The active layer (layer containing the active material) is 10 cm. The volumetric energy at the supercapacitor (without bar) is 4.4 Wh/L at 2.4 V.

The necessary space between each supercapacitor to prevent short-circuiting problems is 2 mm on each side of a supercapacitor. This space is the same between a supercapacitor and the sidewall of the module. The thickness of the sidewalls is 3 mm. The thickness of the elastomer insulators (upper and lower) is 3 mm each. The thickness of the upper and lower covers is also 3 mm.

The volume of the module is therefore equal to: 328 mm×648 mm×122 mm=25.9 litres. The volumetric energy of this module is 2.15 Wh/L. In the field of automotive vehicles it is sometimes useful for vehicles consuming greater energy to provide a module having higher energy (e.g. up to 500 kJ). Nonetheless, for obvious economic reasons—choice of converter, interconnects and electronic circuit boards—the working voltage will be the same (maximum 120 V). This voltage is generally set by the converter, by associated power electronics and the electric motor used.

Applying the same type of sizing (2.7 V/supercapacitor, Uₘₐₓ=120 V and Uₘᵢₙ=60 V), the unit supercapacitance is 4167 F. The diameter of each component is then 6.7 cm and the height of the component is 17.8 cm. The energy density of the component is then 4.2 Wh/L at 2.7 V. The volume of the module is then H×L×W (in dm)=1.9×6.29 (row of 9 components)×3.53 (row of 5 components)=42.2 L. The energy density of the module is then 3.30 Wh/L.

The above calculations are made as explained above, taking into account the characteristics of the module made from the following coiled components of unit capacitance 4167 F:

Organisation: 9 rows of 5 lines of components (total of 45). Intercomponent space: 2 mm.

Thickness of the bar included in the lid.

Thickness of the lids: 3 mm

Thickness of elastomer insulators: 3 mm.

For an application having a peak working amperage of 500 A, the two supercapacitors connected to the terminals of the module are subjected to very high amperage and hence to high over-heating compared with the other supercapacitors of the module, and hence to accelerated ageing.

In addition, the assembling of the supercapacitors into a module has a major disadvantage: the potential of each supercapacitor at the lower (respectively upper) lid is different at every point. This requires the adding of electrically insulating materials able to withstand a high breakdown voltage. However, the materials used must be thermally capable of evacuating heat which also generally entails a major difficulty for the obtaining of a module which performs well. The invention provides most interesting means for overcoming this problem and for strongly limiting the use of these costly materials.

### Measurement of the Characteristics of a Module of Supercapacitors According to the Invention

Appended Table III gives the sizing of modules of varying energy (200 kJ and 500 kJ). With the invention it is possible to meet different required energy values but with one same voltage level and one same type of energy storage assembly of which only the number thereof varies. These assemblies, or supercapacitors, are electrically connected in parallel to obtain the aforementioned result.

As shown by the result obtained with the 500 kJ module, for an identical voltage the volume is reduced by 28% compared with the solution proposed using coiled components.

For the 200 kJ module, the gain is 45%.

The invention also shows that it is not necessary to increase voltage to reach a high energy density.

In the prior art, as detailed above, the obtaining of modules with variable energy but with identical voltage cannot be based on an identical unit since the voltage and capacitance parameters vary when the number of supercapacitors of identical capacitance is changed. This is economically detrimental.

In the invention, an identical unit assembly can be adopted to obtain different energy values when the voltage is identical, as shown in Table III, since the voltage of the assembly is the voltage of the application. This strategy strongly simplifies assembling and reduces the manufacturing costs of such assemblies with a view to forming a module.

### Example of Sizing Using Supercapacitors of the Invention

The supercapacitors of the invention are capable of operating at the application voltage.

Let us assume the following input data, identical to the data used to prepare the prior art module:

Umax_{application}=120 V; Umin_{application}=60 V
Required energy: 200 kJ.

The voltage of each supercapacitor is a function of the number of sheets stacked in the stacked element.

If drastic limiting of ageing is required, it is possible to cause the opposite-facing electrodes to operate at a maximum voltage of 2.4 V.

With 51 sheets (hence 50 planar capacitors in series) the voltage between electrodes is 2.40 V. It will be noted that the number of sheets is not a limiting factor as regards choice: there is nothing to prevent the use of only 45 sheets operating in pairs at 2.7 V.

The capacitance to be reached is 37.04 F for the final module. By using a prismatic supercapacitor having a unit capacitance of 4.63 F, it is sufficient to mount 8 prismatic supercapacitors (or assemblies) in parallel to obtain the final desired module.

Unit dimensions of the sheet:

Electrode capacitance: 30 F/cm³

49 double-sided stacked sheets of thickness 230 μm and 2 single-sided sheets of thickness 130 μm identical to those used in the preceding example (i.e. a total of 51 sheets).

A width of 16 cm is a good compromise to limit resistance with a complex of this thickness. The volume of an electrode is therefore calculated as follows:

Volume of an electrode=L×16×0.01 cm³.

The theoretical capacitance to be attained is 4.63 Farad, as explained above. It is calculated as follows:

Theoretical capacitance to be reached=electrode volume×volumetric capacitance/number of stacked supercapacitors (=number of separators)=electrode volume×30/50.

The volume of an electrode layer is therefore 7.712 cm³.

The length of the unit electrode is therefore L=7.712/(0.01×16) i.e. about 48.2 cm (or 482 mm as indicated in Table III).

As can be seen, the sizing of the electrode is solely limited by the length of the electrode, which amounts to sizing the length of the housing for the final module covering the electrode i.e. not a mechanical part but a film that can be unwound and cut to the desired size. It is therefore easy to adapt the assembly to the desired application.

The final module will therefore have the following minimum dimensions (reference can be made to Table III).

For each assembly:
Separator (number: 50): thickness=25 μm and width size=17 cm×49.2 cm
Double-sided electrodes (number: 49): thickness=230 μm
Single-sided electrodes (number: 2) thickness=130 μm.

These electrodes have an active size of 16 cm×48.2 cm and the single-sided electrodes also comprise a collecting extension (forming a connection terminal) of 3 cm, increasing the width of the module.

Casing to form the housing of thickness 2 mm (hence a total of 4 mm as indicated in Table III) and outer dimensions: (16+2) cm×(48.2+2) cm=18 cm×50.2 cm.

Therefore the following dimensions are obtained for the assembly:

Total thickness: 1.7 cm;

Total height: 19 cm (taking into account the collecting extension);

Total length: 50.2 cm.

The total dimensions of the module comprising 8 assemblies of 4.63 F/unit at 120 V such as described above are as follows:

Width of module: 14.5 cm;

Total length: 51.2 cm (taking into account the necessary spacing for assembling the assemblies);

Total height: 19 cm.

This width is reached since, between the assemblies a spacer is added for efficient heat evacuation (heat-conductive material). Each spacer may have a thickness of 1 mm.

Consideration is also given to the thickness of the sidewalls of the final module, which may be 3 mm. These sidewalls are chosen to be insulating or conductive depending on the positioning of the module terminals, so as not to perturb the electrical functioning of the supercapacitor.

The module does not require balancing circuitry since the unit voltages between sheets are low (2.4 V) and the assemblies are mounted in parallel.

A module is therefore obtained having a total volume of: 51.2×14.5×19=14.1 litres.

This therefore represents a savings of 45% in volume compared with a module core made from cylindrical supercapacitors operating at the same voltage.

The volumetric energy density is therefore: 200 kJ/14.1 L=3.9 Wh/L even though the unit working voltage of the electrodes is 2.4 V.

It will be noted that the current of each assembly remains low although the current of the module is high, since the current of each branch is the division of the total current by the number of energy storage assemblies. In the case of the module size here, the application requires a peak current in the order of 500 A on the module. This therefore leads to a unit current of 67.5 A for each assembly which is relatively low. The heating of each supercapacitor is therefore quite limited.

It will be appreciated that one advantage of the invention is to size the module directly via the maximum voltage given by the application.

The desired capacitance level is then determined by the energy to be supplied. The energy is therefore directly dependent upon the capacitance to be provided (by summing) which corresponds to parallel assembling of supercapacitors whose pre-required voltage level is already reached.

Conversely, by fabricating supercapacitors having high capacitance value and low unit voltage, it is generally complex to best meet the constraints of the application on account of the voltage level to be reached: it is therefore simpler to assemble together assemblies of high voltage and low capacitance than the reverse.

A further advantage of a module working at high voltage is the possibility of using a DC/DC converter between the module of supercapacitors and the application (of variable voltage) using lower currents than when operating at low voltage.

To summarize, the advantages of the above-described supercapacitor are the following:
the voltage of the intended application is directly obtained by the number of complexes superimposed on each other in one same assembly;
the required energy is obtained by associating the necessary number of assemblies in parallel;
the energy density of the modules using supercapacitors of the invention is higher than that of modules made from cylindrical supercapacitors of same voltage and same capacitance;
the series resistance of the supercapacitor of the invention is low since an entire electrode face can be welded or brazed directly onto the lid;
current collections of the supercapacitor of the invention are obtained much more simply than with a prior art prismatic supercapacitor, and

therefore the number of parts used is much lower (optimized fabrication costs);
the supercapacitor may comprise a single separator instead of two in cylindrical supercapacitors;
the polarities of the supercapacitor of the invention can be arranged either side of the supercapacitor, contrary to prior art prismatic supercapacitors. This also allows better dissipation of heating and considerably simplifies the assembling in parallel of these different modules;
the current of each supercapacitor of the invention remains low, even if the current of the module is high, since the current of each branch is the division of the total current by the number of components.

The reader will appreciate that numerous modifications can be made to the above-described storage assembly and module without departing in substance from the novel teachings and advantages described herein.

Therefore any modifications of this type are to be construed as being incorporated within the scope of the appended claims.

### ANNEX

TABLE I

| | RsDC | Capacitance | Time constant |
|---|---|---|---|
| Stack N^{o} | (mOhms) | (Farads) | (s) |
| Cell 1 | 261.4 | 3.10 | 0.81 |
| Cell 2 | 238.0 | 3.21 | 0.76 |
| Cell 3 | 222.0 | 3.44 | 0.76 |
| Cell 4 | 215.0 | 3.43 | 0.74 |
| Cell 5 | 242.4 | 3.21 | 0.78 |
| Cell 6 | 252.1 | 3.25 | 0.82 |
| Cell 7 | 232.4 | 3.40 | 0.79 |
| Mean | 237.6 | 3.29 | 0.78 |

TABLE II

| | Prismatic | | Maxwell | |
|---|---|---|---|---|
| | Cell LS | 20-cell | Cylindrical | 20-cell |
| Type of component | Cable | module | Cell | Module |
| Unit capacitance (F) | 3000 F | 150 F | 3000 F | 150 F |
| Maximum voltage (V) | 2.8 V | 56 V | 2.7 V | 56 V |
| Internal resistance (ESR in mΩ) | 0.36 | Min 7.2 | 0.29 | Min 5.8 |
| Volumetric energy density (at | 5.03 | Max 5.03/ | 5.93 | Max 5.93/ |
| 2.8 V in Wh/L) | | component | | component |
| Gravimetric energy density (at | 6.97 | Max 6.97 | 6.87 | Max 5.39 |
| 2.8 V in Wh/kg) | | | | |
| Number of parts in the | 16 | — | 10 | — |
| supercapacitor | | | | |

TABLE III

| | Invention | | | | | | | | | | | | Prior art | |
|---|---|---|---|---|---|---|---|---|---|---|---|---|---|---|
| Energy | 200 | 500 | 200 | 500 | 200 | 500 | 200 | 500 | 200 | 500 | 200 | 500 | 200 | 500 |
| requirement | | | | | | | | | | | | | | |
| (kJ) | | | | | | | | | | | | | | |
| Umax | 120 | 120 | 120 | 120 | 120 | 120 | 120 | 120 | 120 | 120 | 120 | 120 | 120 | 120 |
| Umin | 60 | 60 | 60 | 60 | 60 | 60 | 60 | 60 | 60 | 60 | 60 | 60 | 60 | 60 |
| Target | 37.04 | 92.59 | 37.04 | 92.59 | 37.04 | 92.59 | 37.04 | 92.59 | 37.04 | 92.59 | 37.04 | 92.59 | 37.04 | 92.59 |
| capacitance (F) | | | | | | | | | | | | | | |
| Width (mm) | 160 | 160 | 160 | 160 | 160 | 160 | 160 | 160 | 160 | 160 | 160 | 160 | 160 | 160 |
| (i.e. height | | | | | | | | | | | | | | |
| ministack) | | | | | | | | | | | | | | |
| Length (mm) | 530 | 530 | 502 | 502 | 482 | 482 | 463 | 463 | 444 | 444 | 435 | 435 | | |
| Number of | 55 | 55 | 52 | 52 | 50 | 50 | 48 | 48 | 46 | 46 | 45 | 45 | 50 | 45 |
| supercapacitors | | | | | | | | | | | | | | |
| Voltage | 2.18 | 2.18 | 2.31 | 2.31 | 2.40 | 2.40 | 2.50 | 2.50 | 2.61 | 2.61 | 2.67 | 2.67 | 2.40 | 2.67 |
| between | | | | | | | | | | | | | | |
| layers (V) | | | | | | | | | | | | | | |
| Complex | 100 | 100 | 100 | 100 | 100 | 100 | 100 | 100 | 100 | 100 | 100 | 100 | 100 | 100 |
| thickness (μm) | | | | | | | | | | | | | | |
| Collector | 30 | 30 | 30 | 30 | 30 | 30 | 30 | 30 | 30 | 30 | 30 | 30 | 30 | 30 |
| thickness (μm) | | | | | | | | | | | | | | |
| Number of | 54 | 54 | 51 | 51 | 49 | 49 | 47 | 47 | 45 | 45 | 44 | 44 | | |
| complexes | | | | | | | | | | | | | | |
| 100/30/100 | | | | | | | | | | | | | | |
| Separator | 25 | 25 | 25 | 25 | 25 | 25 | 25 | 25 | 25 | 25 | 25 | 25 | 25 | 25 |
| thickness (μm) | | | | | | | | | | | | | | |
| Number of | 55 | 55 | 52 | 52 | 50 | 50 | 48 | 48 | 46 | 46 | 45 | 45 | | |
| separators | | | | | | | | | | | | | | |
| 1 single-sided | 2 | 2 | 2 | 2 | 2 | 2 | 2 | 2 | 2 | 2 | 2 | 2 | | |
| 100 μm + | | | | | | | | | | | | | | |
| coll 30 μm | | | | | | | | | | | | | | |
| Volumetric | 30 | 30 | 30 | 30 | 30 | 30 | 30 | 30 | 30 | 30 | 30 | 30 | 30 | 30 |
| capacitance | | | | | | | | | | | | | | |
| (F/cm3) | | | | | | | | | | | | | | |
| Volume of an | 8.48 | 8.48 | 8.032 | 8.032 | 7.712 | 7.712 | 7.408 | 7.408 | 7.104 | 7.104 | 6.96 | 6.96 | | |
| electrode layer | | | | | | | | | | | | | | |
| (cm3) | | | | | | | | | | | | | | |
| Unit | 4.63 | 4.63 | 4.63 | 4.63 | 4.63 | 4.63 | 4.63 | 4.63 | 4.63 | 4.63 | 4.64 | 4.64 | 1852 | 4167 |
| capacitance (F) | | | | | | | | | | | | | | |
| Number of | 8.0 | 20.0 | 8.0 | 20.0 | 8.0 | 20.0 | 8.0 | 20.0 | 8.0 | 20.0 | 8.0 | 20.0 | | |
| required | | | | | | | | | | | | | | |
| ministacks | | | | | | | | | | | | | | |
| Ministack | 2 | 2 | 2 | 2 | 2 | 2 | 2 | 2 | 2 | 2 | 2 | 2 | | |
| casing | | | | | | | | | | | | | | |
| thickness (mm) | | | | | | | | | | | | | | |
| Final | 18.315 | 18.315 | 17.55 | 17.55 | 17.04 | 17.04 | 16.53 | 16.53 | 16.02 | 16.02 | 15.765 | 15.765 | | |
| thickness (mm) | | | | | | | | | | | | | | |
| Width | 30 | 30 | 30 | 30 | 30 | 30 | 30 | 30 | 30 | 30 | 30 | 30 | | |
| projection | | | | | | | | | | | | | | |
| (mm) | | | | | | | | | | | | | | |
| Length | 30 | 30 | 30 | 30 | 30 | 30 | 30 | 30 | 30 | 30 | 30 | 30 | | |
| projection | | | | | | | | | | | | | | |
| (mm) | | | | | | | | | | | | | | |
| Spacer between | 1 | 1 | 1 | 1 | 1 | 1 | 1 | 1 | 1 | 1 | 1 | 1 | | |
| ministack | | | | | | | | | | | | | | |
| Sidewall | 3 | 3 | 3 | 3 | 3 | 3 | 3 | 3 | 3 | 3 | 3 | 3 | 3 | 3 |
| thickness (mm) | | | | | | | | | | | | | | |
| Final stack | 190 | 190 | 190 | 190 | 190 | 190 | 190 | 190 | 190 | 190 | 190 | 190 | 122 | 190 |
| height | | | | | | | | | | | | | | |
| Final stack | 155.7 | 387.6 | 149.3 | 371.7 | 145.4 | 362.0 | 141.2 | 351.6 | 137.1 | 341.1 | 134.8 | 335.6 | 328.0 | 347.0 |
| width (mm) | | | | | | | | | | | | | | |
| Final stack | 560 | 560 | 532 | 532 | 512 | 512 | 493 | 493 | 474 | 474 | 465 | 465 | 648 | 623 |
| length | | | | | | | | | | | | | | |
| Final stack | 16.6 | 41.2 | 15.1 | 37.6 | 14.1 | 35.2 | 13.2 | 32.9 | 12.3 | 30.7 | 11.9 | 29.6 | 25.9 | 41.1 |
| volume (L) | | | | | | | | | | | | | | |
| Volumetric | 3.35 | 3.37 | 3.68 | 3.70 | 3.93 | 3.94 | 4.20 | 4.22 | 4.50 | 4.52 | 4.66 | 4.68 | 2.14 | 3.38 |
| energy (Wh/L) | | | | | | | | | | | | | | |
| Length | 233.4 | 583.5 | 208.6 | 521.6 | 192.9 | 482.3 | 177.8 | 444.4 | 163.3 | 408.2 | 156.3 | 390.6 | | |
| electrode reel | | | | | | | | | | | | | | |
| width 160 (m) | | | | | | | | | | | | | | |

1. An electrical energy storage assembly comprising:
at least three stacked, each comprising at least one electrode;
at least one separator arranged so that said at least one separator is arranged between each pair of adjacent complexes;
two connection terminals to connect the assembly electrically to a voltage generator, a first sample of complexes being electrically connected to or forming one of the two terminals, and a second sample of complexes being electrically connected to or forming the other of the two terminals, the two samples being chosen so that the number of complexes belonging to the combining of the two samples is lower than the total number of complexes and so that the intersection of the two samples is a void assembly.

2. The assembly according to claim 1 wherein each of the complexes located at one end of the stack is connected to or forms one of the connection terminals, each particularly being connected to or forming a separate connection terminal.

3. The energy storage assembly according to claim 1 which comprises at least one complex including a current collector and two opposite electrodes either side of the current collector.

4. The assembly according to claim 3 wherein one of the two electrodes is of greater thickness than the other of the electrodes.

5. The assembly according to claim 3 wherein the two electrodes are of different composition.

6. The assembly according to claim 1 wherein at least one, preferably each complex located at one end of the stack is formed of a current collector and of a single electrode on its surface facing the remainder of the stack.

7. The assembly according to claim 1 wherein:
the separator extends accordion-wise and comprises at least three sections, two adjacent sections being connected at a fold-line to form a fold having a concave side and a convex side;
at least one of the complexes forming a first complex extending chevron-wise and being positioned on a first face of the separator, each first complex being folded along a fold-line and being arranged on a respective convex side of the first face of the separator, so that the fold-line of each first complex coincides with a respective fold-line of the separator;
at least one other of the complexes forming a second complex extending chevron-wise and being positioned on a second face of the separator, each second complex being folded along a fold-line and being arranged on a respective convex side of the second face of the separator so that the fold-line of each second complex coincides with a respective fold-line of the separator.

8. The electrical energy storage assembly according to the preceding claim 7 which comprises:
a plurality of first complexes on the first face of the separator, the first complexes being positioned on every other convex side; and
a plurality of second complexes on the second face of the separator, the second complexes being positioned on every other convex side.

9. The assembly according to claim 7 wherein the fold-lines of the separator form the sides of the stack, one section of a first complex forming the top of the stack and one section of a second complex forming the underside of the stack.

10. The assembly according to claim 1, comprising at least one measuring terminal to measure the voltage between a connection terminal and the measuring terminal, a complex belonging neither to the first nor to the second sample being connected to or forming the measuring terminal.

11. The assembly according to claim 1 further comprising a housing intended to receive the stack, and two lids intended to cap the housing and forming connection terminals of the assembly, the complex located at one end of the stack belonging to the first sample and being electrically connected to the first lid, preferably over the entire surface thereof, and the complex located at the other end of the stack belonging to the second sample and being electrically connected to the second lid, preferably over the entire surface thereof.

12. An energy storage assembly according to claim 1 wherein the housing is made in a flexible material, the complexes belonging to the first and second samples comprising a portion formed in particular by a portion of the collector extending outside the flexible housing, so that the portions of the complexes of one same sample form a connection terminal of the assembly.

13. The assembly according to claim 1 wherein at least one separator is in one piece with a complex, preferably a folded separator is in one piece with a complex so as to cover the two opposite surfaces of this complex.

14. The assembly according to claim 1, comprising an organic electrolyte such as tetraethylammonium difluoromono[1,2-oxalato(2-)-o,o′]borat(1-), (or TEABF₂Ox), the number of complexes and the distribution of the complexes of the first and second samples being chosen so that the local voltage between every pair of adjacent complexes of the assembly is less than 6 V, preferably 3 V.

15. The assembly according to claim 1 comprising an aqueous electrolyte such as potash, sodium hydroxide, sulfuric acid, sodium nitrate, sodium sulfate, lithium nitrate, lithium sulfate, the number of complexes and the distribution of the complexes of the first and second samples being chosen so that the voltage between every pair of adjacent complexes of the assembly is less than 2 V, preferably 1 V.

16. A module comprising a casing in which there is arranged at least one electrical energy storage assembly according to claim 1.

17. The module according to claim 16 comprising a plurality of assemblies, said assembles being electrically connected in parallel.

18. The module according to claim 17 wherein each assembly comprises first and second connection terminals projecting from a flexible housing containing a stack, the assemblies being superimposed and secured together to form a block, the assemblies being arranged so that the first connection terminals are electrically connected together, in particular via a first metal plate, and the second connection terminals are electrically connected together in particular via a second metal plate.

19. The module according to claim 18 wherein the connection terminals of the assemblies are laid flat and assembled directly onto the metal plates.

20. The module according to claim 18 wherein the metal plates comprise grooves.

21. The module according to claim 18 wherein each metal plate comprises a pin preferably positioned in the centre of the plate, the pins allowing the electrical connection of the module to an external electrical member.

22. The module according to claim 18 which further comprises at least one interstice provided between two adjacent assemblies.
